(19) United States
(12) Patent Application Publication
(10) Pub. No.: US 2010/0139070 A1
(43) Pub. Date: Jun. 10, 2010

(54) Device and A Method Thereof for Producing A Patterned Plate

(76) Inventors: Tung-Chen Cheng, Kaohsiung City (TW); Yu-Yi Chu, Kaohsiung City (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/345,808

(22) Filed: Dec. 30, 2008

(30) Foreign Application Priority Data
Dec. 9, 2008 (TW) 097147895

(51) Int. Cl. B23P 17/00; B21D 26/02

(52) U.S. Cl. 29/419.2; 72/56

(57) ABSTRACT

A device for producing a patterned plate from a tubular work piece is disclosed wherein walls of the tubular work piece comprise at least one forming surface. The device comprises a die and an electromagnetic actuator, wherein the die comprises a patterned surface with a pattern formed thereon and a fracturing part. The tubular work piece is disposed between the die and the electromagnetic actuator such that the walls of the tubular work piece correspond to walls of the die, and the forming surface corresponds to the patterned surface. When the electromagnetic actuator is supplied with a current pulse, an eddy current is induced in the tubular work piece, generating a repulsive force between the electromagnetic actuator and the tubular work piece. Therefore, the tubular work piece impacts the die, and the forming surface is deformed against the patterned surface and the fracturing part, thus replicating the pattern of the patterned surface onto the forming surface. At the same time, the tubular work piece is fractured at the position corresponding to the fracturing part. A method for producing a patterned plate from a tubular work piece is also disclosed.

### BACKGROUND OF THE INVENTION

1. Field of the Invention

The present invention relates to a device and a method thereof for producing a patterned plate from a tubular work piece, and in particular, the present invention relates to a device and a method thereof which employs an electromagnetic forming process for producing a patterned plate from a tubular work piece.

2. Description of the Related Art

U.S. Pat. No. 7,076,981 discloses a method of forming a bipolar plate through an electromagnetic forming process. A metal plate is used in the process, and when an external force is exerted upon the metal plate, it is pressed against a conductive frame, and an induced Eddy current is produced. The problem of spark discharge often arises during the pulsing of the induced current, causing safety and yield rate concerns during mass production.

U.S. Pat. No. 7,178,374 discloses a method of forming a bipolar plate through a press forming process. The press forming technique of the patent involves designing a die, such that the stress distribution of the plate material is controlled to produce a plate with a uniform thickness. This method is intended to reduce the curving effect caused by the residual stress in the work-pieces, and to enhance the overall formation process. However, it is still possible for some residual stress to reside in the work-pieces.

U.S. Pat. No. 6,938,449 discloses a simplified hydraulic forming device, comprising an upper die which is able to move upward and downward, and fixed bottom die filled with a liquid. The liquid inside the die is sealed by a plate and a blank holder. The pressure of the fluid is increased by pressing down the upper die toward an accommodating section of the fluid, whereby a part of the plate is deformed. However, the hydraulic forming process patented is not suitable for producing a fine pattern.

Therefore, an improved device and a method thereof for producing a pattern is desired to overcome the above-mentioned shortcomings.

### SUMMARY OF THE INVENTION

One object of the present invention is to provide a device and a method thereof for producing a patterned plate efficiently.

Another object of the present invention is to provide a device having a quasi-hydrostatic effect and a method thereof for producing a patterned plate.

A third object of the present invention is to provide a device and a method thereof for producing a patterned plate, which prevents the problem of spark discharge.

In order to achieve the above-mentioned objectives, the present invention provides a device for producing a patterned plate from a tubular work piece. The device comprises a die and an electromagnetic actuator. Walls of the die comprise at least one patterned surface with a pattern formed thereon and at least one fracturing part. The tubular work piece is disposed between the die and the electromagnetic actuator; walls of the tubular work piece correspond to the walls of the die and a forming surface of the tubular work piece corresponds to the patterned surface of the die. When the electromagnetic actuator is supplied with a current pulse, a current is induced in the tubular work piece and a repulsive force generated between the electromagnetic actuator and the tubular work piece. The repulsive force causes the walls of the tubular work piece to impact the walls of the die, and deforms the forming surface against the patterned surface such that the forming surface replicates the pattern of the patterned surface. Meanwhile the tubular work piece is fractured at the position corresponding to the fracturing part.

Please note that the electromagnetic actuator can be either inside the die or outside the die.

To achieve the above-mentioned objectives, the present invention also provides a method for producing a patterned plate from a tubular work piece. The method comprises the following steps: disposing the tubular work piece between a die and an electromagnetic actuator, wherein walls of the tubular work piece correspond to walls of the die and a forming surface of the tubular work piece corresponds to a patterned surface of the die; supplying a current pulse to the electromagnetic actuator to induce a current in the tubular work piece, thus generating a repulsive force between the electromagnetic actuator and the tubular work piece, wherein the repulsive force causes the walls of the tubular work piece to impact on the walls of the die, and deforms the forming surface of the tubular work piece against the corresponding patterned surface of the die such that the forming surface takes on a pattern of the patterned surface; and cutting the patterned forming surface and separating it from the tubular work piece to form a plate.

Please note that before placing the tubular work piece between the die and the electromagnetic actuator, a prior step is needed: placing the die inside the electromagnetic actuator or placing the electromagnetic actuator inside the die.

### BRIEF DESCRIPTION OF THE DRAWINGS

FIG. 1 shows an assembly view of the first embodiment of a pattern-producing device of present invention.

FIG. 2 shows a cross-sectional view of the first embodiment of the pattern-producing device of the present invention.

FIG. 3 shows a fracturing part of the pattern-producing device of the present invention.

FIG. 4 shows another fracturing part of the present invention.

FIG. 5 shows a cross-sectional view of a second embodiment of the pattern-producing device of the present invention.

FIG. 6 is a flow chart showing the process of producing a pattern of the present invention.

### DETAILED DESCRIPTION OF THE PREFERRED EMBODIMENT

The advantages and innovative features of the invention will become more apparent from the following preferred embodiments.

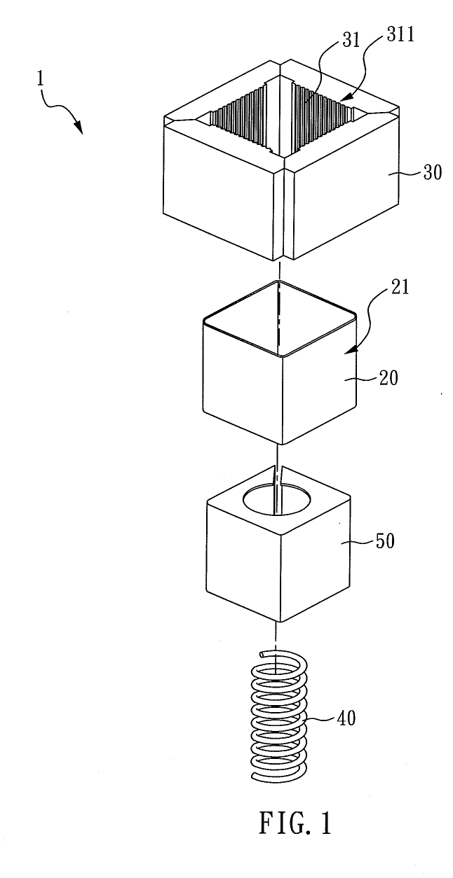

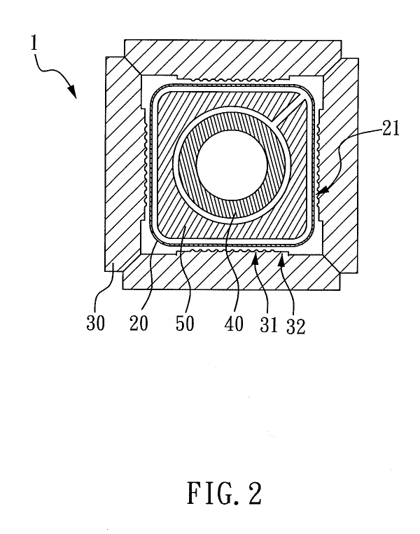

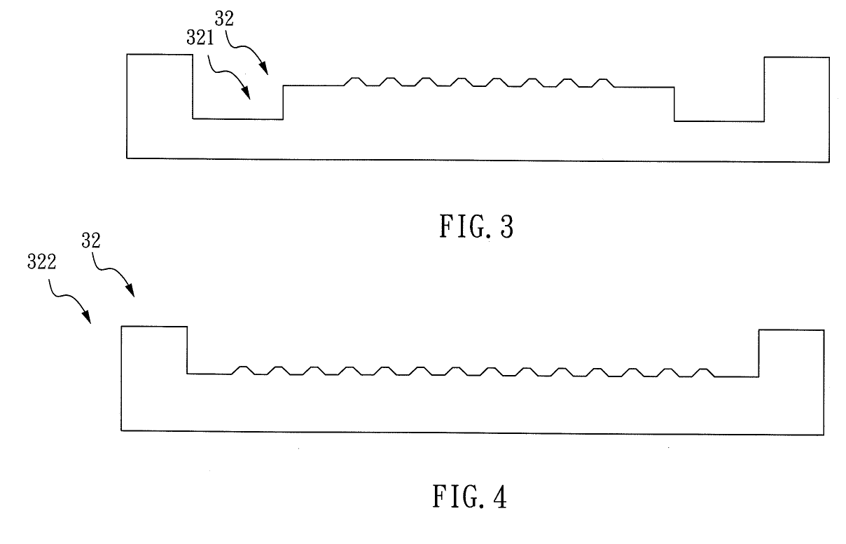

Refer to FIG. 1 to FIG. 4 for the first embodiment of a pattern-producing device in accordance with the present invention. FIG. 1 shows an assembly view of the first embodiment of a pattern-producing device in accordance with the present invention. FIG. 2 shows a cross-sectional view of the first embodiment. FIG. 3 shows a fracturing part of the pattern-producing device in accordance with the present invention. FIG. 4 shows another fracturing part of the pattern-producing device in accordance with the present invention.

As shown in FIG. 1, a pattern-producing device comprises a die 30, an electromagnetic actuator 40 and a magnetic concentrator 50, wherein the die 30 is a tube-shape die, and inner walls of the die 30 comprise a patterned surface 31 with a pattern 311 formed thereon as well as a fracturing part 32. The dimension of the pattern 311 ranges from 1 μm to 10 mm, but the present invention is not limited only to this specification. The fracturing part 32 can either be an indented groove 321 (as shown in FIG. 3) or a protruding part 322 (as shown in FIG. 4), but the present invention is not limited only to these shapes. In the first embodiment, the electromagnetic actuator 40 is made of an electromagnetic coil.

As shown in FIG. 1 and FIG. 2, the electromagnetic actuator 40 of the first embodiment is positioned inside the die 30. Walls of the tubular work piece 20 comprise at least one forming surface 21. The tubular work piece 20 is disposed between the die 30 and the electromagnetic actuator 40, the walls of the tubular work piece 20 correspond to the inner walls of the die 30, and the forming surface 21 corresponds to the patterned surface 31. When the electromagnetic actuator 40 is supplied with a current pulse, the current pulse induces a current in the tubular work piece 20. A repulsive force is consequently generated between the electromagnetic actuator 40 and the tubular work piece 20. The repulsive force then causes the walls of the tubular work piece 20 to move rapidly towards the inner walls of the die 30 and to impact on the patterned surface 31 as well as the fracturing part 32.Therefore, the forming surface 21 of the tubular work piece 20 is deformed against and takes on the pattern 311 of the patterned surface 31, meanwhile, the tubular work piece 20 is fractured at the position corresponding to the fracturing part 32. The pattern 311 is replicated onto the tubular work piece 20 at a high velocity through a quasi-hydrostatic pressure; therefore it has characteristics such as high malleability and fewer spring-back quantities, and creases are prevented from forming. Unlike related prior arts, the conductive frame is not required, and no pressing means is needed to press against the tubular work piece 20 physically while the pattern forming process is performed, thus resolving the problem of spark discharge.

In one of the embodiments, the thickness of the walls of the tubular work piece 20 is substantially between 0.1 mm to 0.4 mm, but the present invention is not limited only to this thickness. The tubular work piece 20 can be made of a metal or any compound material that has a magnetic conducting property. Again, the present invention is not limited to these materials. Any materials that can induce eddy currents when the electromagnetic actuator 40 is supplied with a current are said to fall within the scope of the present invention. The material of the tubular work piece 20 is substantially selected from aluminum, copper, ferrum, aurum, silver, titanium or any alloy combination thereof.

In one of the embodiments, the tubular work piece 20 can be deformed at a speed exceeding 300 m/sec, replicating a pattern in 10 μsec to 100 μsec. However, the present invention is not restricted to these specifications. The aforementioned repulsive force is a non-contact force so the tubular work piece 20 receives an evenly-distributed force and impacts to the patterned surface 31 instantaneously. This quasi-hydrostatic shaping force minimizes the residual stress of the tubular work piece 20.

In one of the embodiments, as shown in FIG. 2, the shapes of the tubular work piece 20 and the die 30 are both rectangular, but the present invention is not restricted to this shape. For example, they can also be circular, triangular, or shapes of other polygons. Although the tubular work piece 20 and the die 30 are both rectangular in this embodiment, the present invention is not limited to this arrangement. For example, the shape of the tubular work piece 20 can be circular, and the die 30 can be other polygons.

In one of the embodiments, the magnetic concentrator 50 is made of copper, but the present invention is not limited only to this material. The magnetic concentrator 50 can also be made of other conductive materials. When the size of the electromagnetic actuator 40 is much smaller than the internal diameter of the die 30, the magnetic concentrator 50 can be positioned between the tubular work piece 20 and the electromagnetic actuator 40 (as shown in FIG. 1 and FIG. 2) to aid induction between the tubular work piece 20 and the electromagnetic actuator 40.

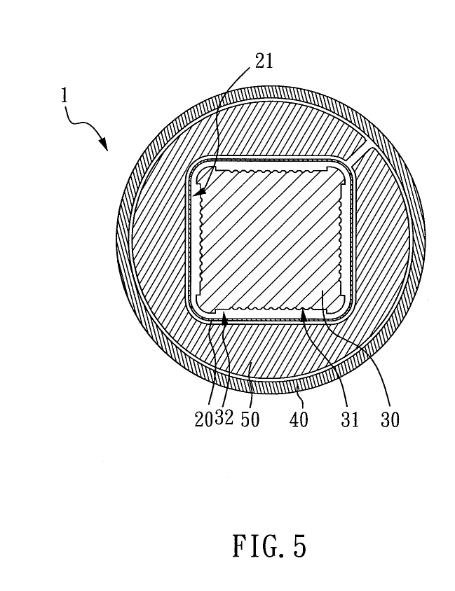

Next, refer to FIG. 5 for the second embodiment of the pattern-producing device in accordance with the present invention. FIG. 5 shows a cross-sectional view of the second embodiment. The second embodiment is different from the first embodiment in that the die 30 is pillar-shaped; external walls of the die 30 comprise at least one patterned surface 31 with a pattern 311 formed thereon and at least one fracturing part 32. The die 30 is positioned inside the electromagnetic actuator 40; the tubular work piece 20 is disposed between the die 30 and the electromagnetic actuator 40. The walls of the tubular work piece 20 correspond to the external walls of the die 30, and the forming surface 21 of the tubular work piece 20 corresponds to the patterned surface 31 of the die 30. When the electromagnetic actuator 40 is supplied with a current pulse, it induces a current in the tubular work piece 20. A repulsive force is consequently generated between the electromagnetic actuator 40 and the tubular work piece 20. By the repulsive force, the walls of the tubular work piece 20 move rapidly towards the external walls of the die 30 and impact on the patterned surface 31 as well as the fracturing part 32. Therefore the forming surface 21 of the tubular work piece 20 is deformed and takes on the pattern 311 of the patterned surface 31 of the die 30. At the same time, the tubular work piece 20 is fractured at the position corresponding to the fracturing part 32.

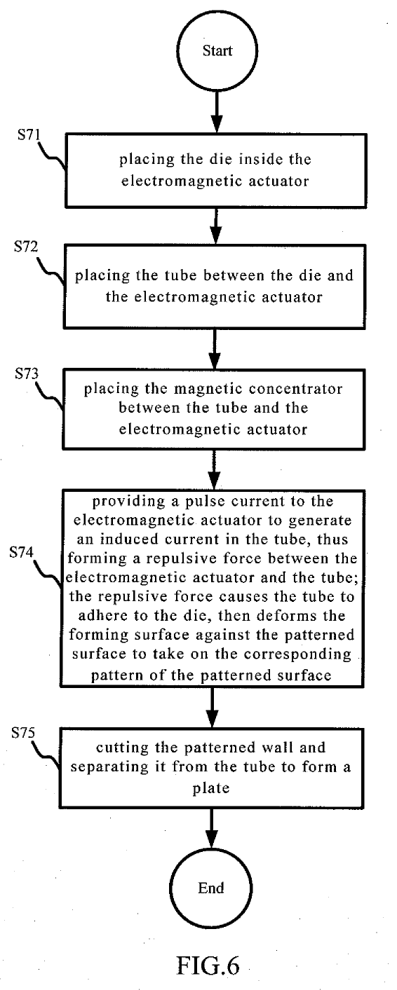

As shown in FIG. 5, the magnetic concentrator 50 of the embodiment is positioned between the tubular work piece 20 and the electromagnetic actuator 40 to aid induction. In this embodiment, the magnetic concentrator 50 and the electromagnetic actuator 40 are both cylindrical, but the present invention is not limited only to this shape arrangement. The present invention also presents a method for producing a pattern onto a plate. Refer to FIG. 6 for a flow chart showing the process of producing a pattern in accordance with the present invention.

First, the method proceeds with step S71: placing a die inside a electromagnetic actuator.

In one of the embodiments, walls of the die comprise at least one patterned surface with a pattern formed thereon. The dimension of the pattern ranges from 1 μm to 10 mm, but the present invention is not limited only to this specification. In one of the embodiments, the electromagnetic actuator is made of an electromagnetic coil.

Please note that in step S71, the electromagnetic actuator can also be placed inside the tube-shaped die, depending on the design or manufacturing requirements of the pattern.

The next step in the process is step S72: disposing a tubular work piece between the die and the electromagnetic actuator such that walls of the tubular work piece correspond to the walls of the die and a forming surface of the tubular work piece corresponds to a patterned surface of the die.

In one of the embodiments, the cross-sectional shape of the tubular work piece can be rectangular, circular, triangular or other polygons. The cross-sectional shape of the tubular work piece can be either the same or different from the cross-sectional shape of the die. The thickness of the walls of the tubular work piece lies between 0.1 mm and 0.4 mm, but the present invention is not limited only to this thickness. The tubular work piece can be made of a metal or a compound material which has a magnetic conducting property. However, the present invention is not limited only to these materials. Any materials, which can induce eddy currents when the electromagnetic actuator is supplied with a current, are said to fall within the scope of the present invention.

In one preferred embodiment, the material of the tubular work piece is substantially selected from aluminum, copper, ferrum, aurum, silver, titanium or any alloy combination thereof.

The process continues with step S73: placing a magnetic concentrator between the tubular work piece and the electromagnetic actuator.

In one of the embodiments, the magnetic concentrator is made of copper, but the present invention is not limited only to this material. The magnetic concentrator can also be made of other conducting materials. Please note that the design of the tubular work piece and the electromagnetic actuator can also be completed without the magnetic concentrator, and that step S73 can be skipped under this scenario.

The next step is step S74: supplying a current pulse to the electromagnetic actuator to induce an eddy current in the tubular work piece, thus generating a repulsive force between the electromagnetic actuator and the tubular work piece; the repulsive force causes the walls of the tubular work piece to impact on the walls of the die, thus deforming the forming surface against the patterned surface to take on the corresponding pattern of the patterned surface.

After the electromagnetic actuator is supplied with a current pulse, the current passes through the electromagnetic actuator and generates a magnetic field. Simultaneously, an induced current is generated in the tubular work piece and an opposite magnetic field is formed to repel against the initial magnetic field. The repelling field forces the walls of the tubular work piece to impact to the patterned surface at a high velocity, causing the forming surface to take on the pattern of the patterned surface permanently. The pattern replicated on the forming surface of the tubular work piece is formed at a high velocity by a quasi-hydrostatic pressure; therefore, it has characteristics such as high malleability and fewer spring-back quantities and prevents creases from forming.

The last step in the process is step S75: cutting the patterned forming surface and separating it from the tubular work piece to form a plate.

In one of the embodiments, the die comprises the fracturing part, wherein the fracturing part can be either an indented groove or a protruding part. After the electromagnetic actuator is supplied with a current, the tubular work piece impacts to the walls of the die at a high velocity and causes the tubular work piece to fracture at the position corresponding to the indented groove or the protruding part of the fracturing part. The patterned forming surface then breaks away from the tubular work piece to form a plate. However, the present invention is not limited only to this cutting method. For example, any mechanical cutting or laser cutting method of the prior arts can also be used to yield the same outcome.

Although the present invention has been explained in relation to its preferred embodiment, it is also of vital importance to acknowledge that many other possible modifications and variations can be made without departing from the spirit and scope of the invention as hereinafter claimed.

What is claimed is:

1. A device for producing a patterned plate from a tubular work piece, wherein walls of the tubular work piece comprise at least one forming surface, and the device for producing a patterned plate comprises:
a die, wherein walls of the die comprise at least one patterned surface with a pattern formed thereon and at least one fracturing part; and
an electromagnetic actuator;
wherein the tubular work piece is disposed between the die and the electromagnetic actuator, such that the walls of the tubular work piece correspond to the walls of the die and the forming surface of the tubular work piece corresponds to the patterned surface of the die; when the electromagnetic actuator is supplied with a current pulse, a current is induced in the tubular work piece, a repulsive force is then generated between the electromagnetic actuator and the tubular work piece; the repulsive force then causes the walls of the tubular work piece to impact the walls of the die, deforming the forming surface against the patterned surface to replicate the pattern, and the tubular work piece is fractured at the position corresponding to the fracturing part.

2. The pattern-producing device as claimed in claim 1, wherein the die is pillar-shaped, and the die is positioned inside the electromagnetic actuator.

3. The pattern-producing device as claimed in claim 1, wherein the die is tube-shaped, and the electromagnetic actuator is positioned inside the die.

4. The pattern-producing device as claimed in claim 1 further comprises a magnetic concentrator, wherein the magnetic concentrator is placed between the die and the electromagnetic actuator, wherein the tubular work piece is disposed between the magnetic concentrator and the die.

5. The pattern-producing device as claimed in claim 1, wherein the fracturing part is an indented groove.

6. The pattern-producing device as claimed in claim 1, wherein the fracturing part is a protruding part.

7. The pattern-producing device as claimed in claim 1, wherein the electromagnetic actuator is an electromagnetic coil.

8. The pattern-producing device as claimed in claim 1, wherein the tubular work piece is made of a metal or any compound material which has a magnetic conducting property.

9. The pattern-producing device as claimed in claim 1, wherein the material of the tubular work piece is substantially selected from aluminum, copper, ferrum, aurum, silver, titanium or any alloy combination thereof.

10. A method for producing a patterned plate from a tubular work piece, comprising:
disposing the tubular work piece between a die and an electromagnetic actuator, wherein walls of the tubular work piece correspond to walls of the die and a forming surface of the tubular work piece corresponds to a patterned surface of the die;
supplying a current pulse to the electromagnetic actuator to induce a current in the tubular work piece, thus generating a repulsive force between the electromagnetic actuator and the tubular work piece, wherein the repulsive force then causes the walls of the tubular work piece to impact on the walls of the die and deforms the forming surface against the corresponding patterned surface to take on a pattern; and
cutting the patterned forming surface and separating it from the tubular work piece to form a plate.

11. The method for producing a patterned plate as claimed in claim 10, further comprising a step of placing the die inside the electromagnetic actuator before disposing the tubular work piece between the die and the electromagnetic actuator, wherein the die is pillar-shaped.

12. The method for producing a patterned plate as claimed in claim 10, further comprising a step of placing the electromagnetic actuator inside the die before disposing the tubular work piece between the die and the electromagnetic actuator, wherein the die is tube-shaped.

13. The method for producing a patterned plate as claimed in claim 10, further comprising a step of placing a magnetic concentrator between the tubular work piece and the electromagnetic actuator before supplying a current pulse to the electromagnetic actuator.

14. The method for producing a patterned plate as claimed in claim 10, wherein the electromagnetic actuator is an electromagnetic coil.

15. The method for producing a patterned plate as claimed in claim 10, wherein the tubular work piece is made of a metal or any compound material which has a magnetic conducting property.

16. The method for producing a patterned plate as claimed in claim 10, wherein the material of the tubular work piece is substantially selected from aluminum, copper, ferrum, aurum, silver, titanium or any alloy combination thereof.

17. The method for producing a patterned plate as claimed in claim 10, wherein the die comprises a fracturing part; the tubular work piece is fractured at the position corresponding to the fracturing part when the walls of the tubular work piece impact to the walls of the die.

18. The method for producing a patterned plate as claimed in claim 17, wherein the fracturing part is an indented groove.

19. The method for producing a patterned plate as claimed in claim 17, wherein the fracturing part is a protruding part.
